(19) United States
(12) Patent Application Publication
(10) Pub. No.: US 2012/0327358 A1
(43) Pub. Date: Dec. 27, 2012

(54) EYEWEAR FRAME WITH DISCRETE SECTIONS OF PARTICULAR CHARACTERISTICS

(76) Inventor: Nicola Iaria, Indianapolis, IN (US)

(21) Appl. No.: 13/529,083

(22) Filed: Jun. 21, 2012

Related U.S. Application Data
(60) Provisional application No. 61/499,245, filed on Jun. 21, 2011.

(51) Int. Cl. G02C 5/02; G02C 5/14

(52) U.S. Cl. 351/111

(57) ABSTRACT

Among other things, there is disclosed embodiments of eyewear frames having a predetermined sequence of discrete material sections that are differentiable, e.g. visually differentiable. Placement of the discrete material sections may be by molding or casting, or by applying the material onto a substrate of the frame.

### CROSS-REFERENCE TO RELATED APPLICATIONS

This application claims the benefit of U.S. Provisional Application No. 61/499,245 filed Jun. 21, 2011, which is hereby incorporated by reference.

### FIELD

The present disclosure concerns eyewear or frames for eyewear. In particular, it discloses eyewear with better identification characteristics.

### BACKGROUND

Basic frame structure for eyeglasses, sunglasses, or novelty eyewear are well known. Such structure commonly includes a main portion that rests at least partly on the bridge of the wearer's nose in front of his or her eyes. One or more side supports (temple arms or earpieces) extend from the main portion to be placed atop the ears.

Such frames have been made of thin metal, as one example, which provides not only sturdiness with a minimum amount of material, but also can be patterned or burnished to give a stylish look. While metal frames have structural and potential ornamental advantages, such materials can be expensive and/or more difficult to fashion than other materials. It is also known to make eyewear frames from synthetic materials, such as hard plastics. These and similar materials are relatively inexpensive and easy to form using a variety of molding, casting or other processes. However, such materials may not provide an expensive image or look for the wearer, and so may be less desirable than metal frames. Plastics can also be more brittle, and so more susceptible to breakage.

Synthetic frames are further generally of a uniform material, for ease of creation and ensuring of consistency or quality. Uniform black frames of a single material throughout are fashionable parts of a number of types of sunglasses, and novelty eyewear similarly includes a single plastic of uniform characteristics. Random swirls of additional substances different from the base material have been introduced for color variation in some types of plastic frames.

There remains a need for eyewear frames and processes for making them that provide for individualization of the frames to the tastes of wearers, for allowing wearers to express affiliation or interest, or for easily allowing others to identify such affiliation or interest.

### SUMMARY

Among other things, there is disclosed an eyewear frame that includes a main part for placement in front of the eyes of the user. The main part may have first and second brackets connected together with a bridge portion. The frame also can include first and second earpieces, with the first earpiece extending from the main part (e.g. the first bracket), and the second earpiece extending from a different location of the main part (e.g. the second bracket). Such earpieces are adapted for placement on and support by respective ears of the user. The frame has at least a portion formed of a plurality of discrete material sections that are visually differentiable from one another, with a defined border between adjacent ones of the discrete sections. The discrete material sections alternate in a predetermined repeating sequence throughout said frame portion.

In particular embodiments, the frame is or has a substrate to which the discrete material sections are attached. As examples, the discrete material sections may be adhesively attached to the substrate, or may be discrete layers of material cured on the substrate. Another example is at least one outer layer attached to the substrate, with the discrete material sections being parts of such outer layer(s). In some embodiments, the discrete material sections of the frame portion are of a substantially uniform width, so that each section is approximately the same size as the others in at least one dimension, to make each section easily differentiable from its adjacent sections. The discrete material sections may be joined together (e.g. when the sections themselves are formed) to form the frame portion. Adjacent ones of the discrete material sections are of different materials joined together during curing in some examples, such as where those different materials include a difference in pigment. Such discrete material sections can be placed together in the form of the frame and cured at one time, or can be formed as the frame or frame portion at one time. The frame portion is the entirety of the main part and earpieces in some embodiments, so that the entire frame has the sequenced discrete material portions. In others, the frame portion with the sequence of discrete material portions includes part or all of the main part and/or earpieces, e.g. at least one of the earpieces but not the main part, or the main part but not the earpieces. In particular embodiments the repeating sequence continues throughout the entirety of the main part and earpieces from an end of the first earpiece through the first earpiece to and through the first bracket, through the bridge portion to and through the second bracket, and from the second bracket through the second earpiece to an end of the second earpiece.

Methods of making eyewear frames as disclosed herein are also provided. As examples, part or all of a frame may be made by casting or molding processes in which different materials are placed in the mold or cast adjacent each other to form the discrete material sections. On curing, the frame or frame part shows the predetermined sequence of discrete material sections. Another example is making part or all of a frame as a substrate or base, and attaching one or more pieces to the substrate as the discrete material sections. Enamel, paint, or other material layers may be placed on the substrate in the predetermined sequence, and their curing provides the discrete material sections in the desired sequence. Adhesive materials may form the discrete material sections, attached next to each other on the substrate.

### BRIEF DESCRIPTION OF THE DRAWINGS

FIG. 1 is a perspective view of an eyewear frame in one embodiment according to this disclosure.

FIG. 1A is a cross-sectional view taken along the lines 1A-1A in FIG. 1 and viewed in the direction of the arrows.

FIG. 2 is a front view of the embodiment of FIG. 1.

FIG. 3 is a top plan view of the embodiment of FIG. 1.

FIG. 4 is a left side elevational view of the embodiment of FIG. 1. A right side elevational view is merely a mirror image, and is not separately shown.

FIG. 5 is a rear view of the embodiment of FIG. 1, with indicator letters left off for the sake of clarity.

FIG. 6 is a perspective view of the embodiment of FIG. 1, with a different arrangement of discrete material sections.

### DETAILED DESCRIPTION OF THE ILLUSTRATED EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claims is thereby intended, and alterations and modifications in the illustrated device, and further applications of the principles of the disclosure as illustrated therein are herein contemplated as would normally occur to one skilled in the art to which the disclosure relates.

Referring now generally to the figures, there is shown an embodiment of an eyewear frame 20. This embodiment of frame 20 includes a main part 22 for placement generally in front of the user's eyes, and a pair of earpieces or temple arms 24, 26 extending from main part 22. As will be described further below, at least a portion of frame 20 is formed of discrete sections of differing materials to provide differentiation (e.g. visual or textural differentiation) among the sections.

Main part 22 includes first and second (or left and right) brackets 30, 32. As seen in the illustrated embodiment, brackets 30, 32 are substantially identical. Accordingly, for convenience an embodiment of bracket 30 will be described, and it will be understood that that description applies to bracket 32 as well. Bracket 30 is shaped as a rounded rectangle, oval, or similar shape designed to remain in front of or cover all or part of the eye. It will be understood that other shapes may be used, as long as the user's vision is not substantially blocked by part of bracket 30.

In the illustrated embodiment, bracket 30 is an enclosed figure, having a complete perimeter 34 that surrounds or encloses a central opening 36. Embodiments of bracket 30 shaped substantially as a rectangle has a perimeter 34 that includes upper and lower struts 38 that are substantially horizontal and side struts 40 that are substantially vertical. In many cases, struts 38 and 40 are molded or otherwise formed as a whole, complete unit rather than as individual pieces later attached together. Nevertheless, the term “struts” is used herein where needed to clarify particular portion(s) of brackets 30, 32.

Central opening 36 can be filled with a lens, such as a vision-correcting lens, a colored light-diminishing (e.g. UV-protective) lens, or a clear protective lens. Alternatively, opening 36 may be left open, without a lens, particularly in cases of novelty frames. In still other embodiments, opening 36 may include no lens, but may have other filler material providing a particular novelty look or other advantage. It will also be appreciated that in other embodiments bracket 30 may not have a complete perimeter, having an opening to one side (e.g. the lower side), forming only an upper strut 38 with or without small side strut(s) 40, or similar configurations. In these non-closed configurations, lenses can be fitted as indicated above to any present struts, or the openings 36 can remain open.

Bridge portion 42 connects brackets 30, 32. In the illustrated embodiment, bridge portion 42 is configured to sit on or about the bridge of the user's nose, so that openings 36 (or portions of them) of brackets 30, 32 on either side of bridge portion 42 are positioned in front of the user's eyes when bridge portion 42 is on or adjacent the user's nose. In particular embodiments, bridge portion 42 is fixed or unitary with respect to each bracket 30, 32.

Earpieces or temple arms 24, 26 are substantially identical in the illustrated embodiment, and so for brevity they will be described with reference to arm 24. Arm 24 has a first free end 44 and a second end 46 that adjoins or is adjacent to main portion 22 (e.g. bracket 30). Between ends 44 and 46 is a body portion 48. In the illustrated embodiment, body portion 48 is substantially linear from end 46 toward end 44, and has a downward-bending portion 50 (as seen in the drawings) as it approaches end 44. Portion 50 bends downward so as to fit behind the ear of the user and limit or prevent movement of frame 20 as the user bends, twists or otherwise moves his or her head. It will be understood that in other embodiments body portion 48 may have a concave internal curvature so as to more closely fit around a portion of the user's head.

In the illustrated embodiment, each earpiece 24, 26 is fixed or unitary with main portion 22. For example, earpiece 24 is fixed or unitary with bracket 30, so that earpiece 24 cannot move with respect to bracket 30, beyond the ability of earpiece and/or bracket 30 to bend with respect to the other portion. Likewise, earpiece 26 may be fixed or unitary with bracket 32. In other embodiments, one or more hinges (not shown) may be provided between earpiece 24 and bracket 30 and/or between earpiece 26 and bracket 32. If such hinges are provided, then a small space will exist between earpiece(s) 24 and/or 26 and their respective adjacent bracket(s) 30 and/or 32, and one or both earpieces 24, 26 will be foldable through the action of the hinge(s) toward main portion 22, rendering frame 20 more compact for carrying or storage.

Frame 20 is non-homogeneous in its material, having at least a portion that is formed of separate, discrete material sections that are at least visually differentiable from one another. The discrete sections differ in their composition from their adjacent sections. For example, each discrete section can have one or more visual characteristics that differ from sections that are next to them. In one embodiment, one discrete section (A) may be one solid color, while neighboring discrete sections (B) may be another solid color. Other compositional or physical characteristics may be different between sections A and B.

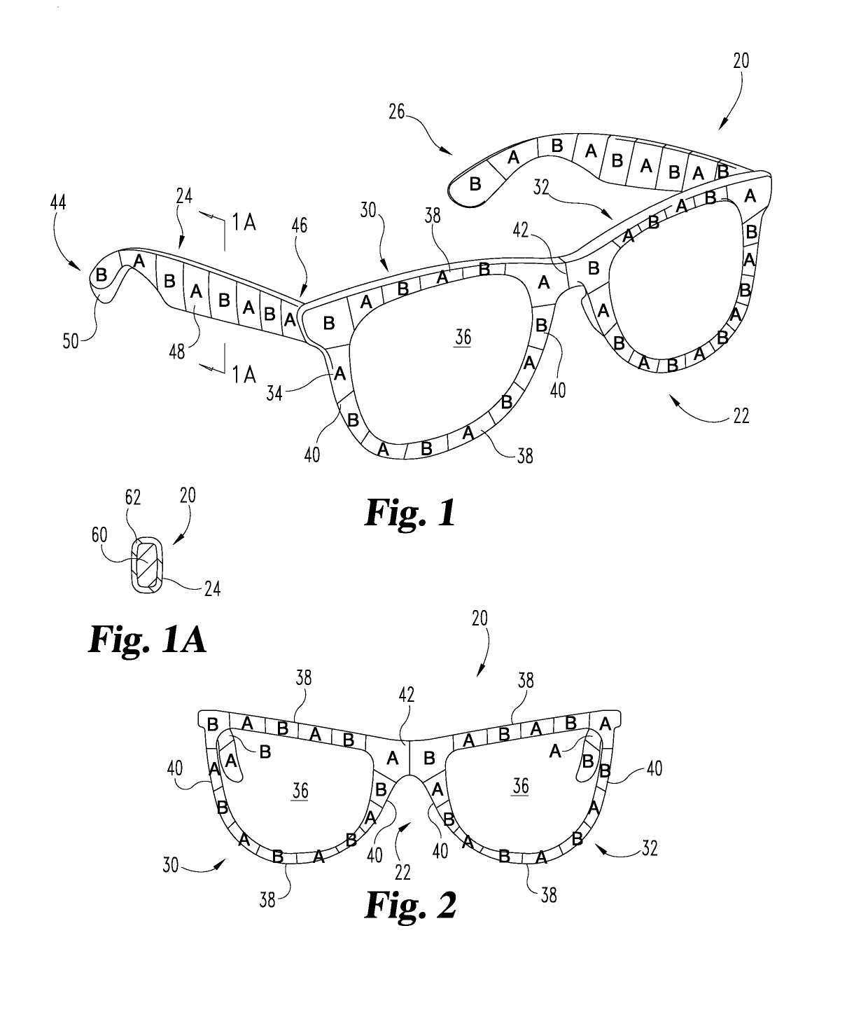

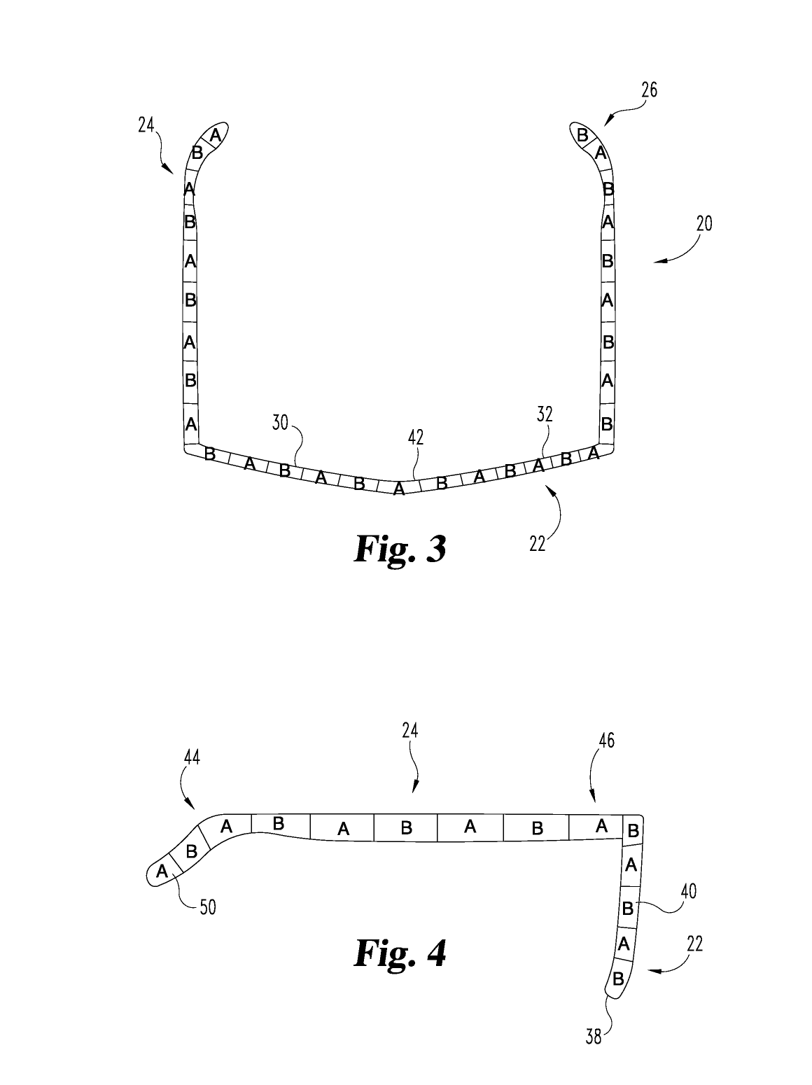

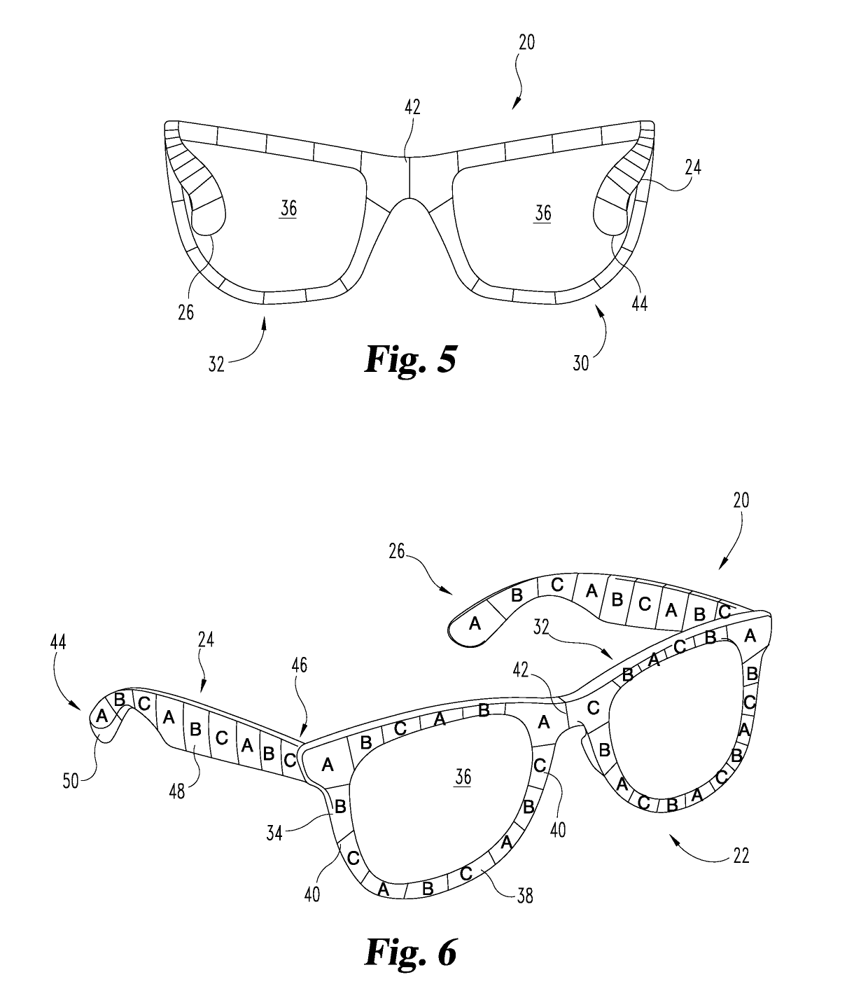

In a particular embodiment, a substrate 60 in the general configuration of frame 20 is formed by molding, with substrate 60 comprising an appropriate plastic chosen for its moldability and sturdiness for use in an eyewear frame. In this particular embodiment, substrate 60 includes a portion for main part 22 and two portions for earpieces 24, 26, with earpieces 24, 26 being fixed with main portion 22. Over substrate 60, a non-homogeneous top layer 62 is placed. Layer 62 includes discrete sections A and B that alternate along frame 20. As seen best in FIGS. 1 and 3, end 44 of earpiece 24 has a section A, and a section B adjoins that section A. Sections A and B alternate along the length of earpiece 24. Similarly, layer 62 on main part 22 alternates between sections A and B around each bracket 30, 32. The illustrated embodiment shows the alternation of sections A and B throughout the entirety of frame 20. In other embodiments, only a portion of frame 20 may have the alternating sections, e.g. one or both of earpieces 24, 26 with or without a part of main part 22, or some or all of main part 22 with or without one or both of earpieces 24, 26. The illustrated embodiment shows a sharp border between each such section A and B and neighboring sections. In addition, the illustrated embodiment shows that each such section A and B have approximately the same width or size measured along the length of the respective part of frame 20 (e.g. earpiece 24, or bracket 30). Such a uniformity of length provides consistency to the repeating pattern rendering it more easily observable.

It will be understood that there may be two different types of discrete material sections, as noted immediately above, or in other embodiments there may be three, four or more different types of discrete sections. In the embodiment shown in FIG. 6, three different types of discrete sections (A, B, and C) are shown. As one particular example, the characteristic that differs among the discrete sections of layer 62 in any of the disclosed embodiments is color. Thus, referring to FIG. 6, sections A may have a green surface, sections B may have a white surface, and sections C may have a red surface as a specifically contemplated example. Other examples of two, three or more repeating characteristics such as color are contemplated. Again, this illustrated embodiment shows a substantially uniform length of the individual sections for reasons such as those noted above.

Layer 62 may be affixed atop substrate 60, as by adhesive affixation. In one example, discrete portions of layer 62 each having a single one of the desired characteristic(s) are affixed individually to substrate 60. Thus, a portion of layer 62 having the characteristic(s) of section A is adhesively affixed to end portion 44 of earpiece 24. A portion of layer 62 having the characteristic(s) of section B is similarly placed on substrate 60 next to that section A portion, with a sharp border existing between them. A portion of layer 62 having the characteristic(s) of section C is then similarly placed, and the portions are repeated in the desired order. In this embodiment, layer 62 comprises a plurality of individual materials placed adjacent each other on substrate 60, rather than a single-piece or unitary layer. Layer 62 may alternatively be one or more longer or larger portions having the discrete sections already joined or juxtaposed together. Placement of such a layer 62 on frame 20 (e.g. on an earpiece 24, 26) results in the predetermined sequence of discrete material sections and their respective characteristic(s) being applied to frame 20 in one step.

Layer 62 may be otherwise deposited on the substrate 60 to form frame 20. As one example, discrete amounts of material (e.g. a plastic, enamel, or paint) may be placed in sequence on substrate 60. As indicated above, a material with characteristic A may deposited in one place. Adjacent to that place is the depositing of a material with characteristic B, and adjacent to that location a material with characteristic C is deposited. The sequence of materials is repeated throughout frame 20 or a portion of it. Such materials may be placed by hand, by spraying, by molding or casting, or by other techniques.

In another embodiment, frame 20 is molded using plastics having the desired characteristic(s) in discrete sections. For example, a mold for frame 20 is filled or injected with a first plastic for sections A, and a second plastic for sections B. When frame 20 is cured, the discrete sections A and B remain, as indicated in the figures, all curing together at one time. A border remains between the discrete sections, which may be sharp where there is little or no mixing between the materials or may be somewhat mixed in other cases. Even if there is mixing, the preferred embodiment of frame 20 has particular easily-differentiated geometric sections, in which each section has a substantial part that is clearly different from adjoining sections. In this embodiment there is only a substrate that has the differentiated pattern, rather than a separate substrate 60 and layer 62 as noted above. Again, in the illustrated embodiment a regular pattern of substantially uniform-width or -size sections is shown.

In examples of frame 20 in which earpieces 24, 26 are not fixed to main portion 22, a boundary between discrete sections (e.g. between a section A and a section B) may be found in a gap between earpieces 24, 26 and main portion 22. Such earpieces 24, 26 may be separately made or formed, with their own set of discrete sections, and assembled to a main portion 22 with its set of discrete sections. In such a case, the discrete section of end 40 of earpieces 24, 26 may be different from that of the adjacent portion of main portion 22. In examples of frame 20 in which earpieces 24, 26 are fixed to main portion 22, similarly the section of earpieces 24, 26 that adjoin main portion 22 may have different characteristics (e.g. a different color) than the part of main portion 22 they are fixed to.

Frame 20 can be originally manufactured or created as noted above, e.g. to have discrete sections with a repeating pattern. It is also to be understood that frame 20 can be a previously-prepared frame that is altered or retrofitted to create such sections, as by applying any of the varieties of layer 62 discussed above. Thus, existing eyewear frames can be treated as indicated above with a layer of discrete material sections.

While common eyewear frames have uniform characteristics throughout, the present disclosure provides the opportunity for individualization of frame 20 to particular tastes or interests. If color is the characteristic that changes from discrete section to discrete section, the wearer can express an affiliation with an organization, nationality or other group with frame 20. For example, frame 20 may be prepared with a repeating pattern of visually distinguishable sections of green, red and white to indicate at a glance the user's interest in or affiliation with an Italian-American organization, or similar group. Other repeating patterns of colors or other visually-distinguishable features are usable, and in other embodiments the discrete individual sections may feature a non-repeating selection of colors or visually-distinguishable features.

Where possible, the number of discrete sections and the number of characteristics used in frame 20 permits no two adjacent sections to have the same characteristic. However, some embodiments may have a number of characteristics and/or a number of sections such that a characteristic repeats in adjacent sections. For example, to ensure that the earpieces match in every respect, there may be for a particular configuration of colors and number of sections a need to have two sections (e.g. by bridge portion 42) that have the same color. For similar reasons, there may be configurations in which the pattern does not repeat exactly as one follows it from one side of the frame to the other. For example, in a three-characteristic pattern, where the earpieces are identical, it may be necessary to break the pattern (e.g. missing or leaving out a “B” characteristic-section between “A” and “C” sections) at one or more points to ensure the overall pattern is maintained in the rest of the frame.

While the disclosure has been illustrated and described in detail in the drawings and foregoing description, the same is to be considered as illustrative and not restrictive in character, it being understood that only embodiments have been shown and described and that all changes, equivalents, and modifications that come within the spirit of the disclosures defined by the following claims are desired to be protected. Particular features described with respect to one embodiment or structure are usable with other embodiments or structures disclosed herein.

What is claimed is:

1. An eyewear frame, comprising:
a main part for placement in front of the eyes of the user, said main part including first and second brackets, said first and second brackets being connected together with a bridge portion;
first and second earpieces, said first earpiece extending from said first bracket, said second earpiece extending from said second bracket, wherein said first and second earpieces are adapted for placement on and support by respective ears of the user;
said frame having at least a portion formed of a plurality of discrete material sections visually differentiable from one another, with a defined border between adjacent ones of said discrete sections, said discrete material sections alternating in a predetermined repeating sequence throughout said frame portion, so that said repeating sequence continues throughout the entirety of said frame portion.

2. The frame of claim 1, wherein said frame has a substrate to which said discrete material sections are attached.

3. The frame of claim 2, wherein said discrete material sections are adhesively attached to said substrate.

4. The frame of claim 2, wherein said discrete material sections are discrete layers of material cured on said substrate.

5. The frame of claim 2, further comprising at least one outer layer attached to said substrate, wherein said discrete material sections are parts of said at least one outer layer.

6. The frame of claim 1, wherein said discrete material sections of said frame portion are of a substantially uniform width.

7. The frame of claim 1, wherein said discrete material sections are joined together to form said frame portion.

8. The frame of claim 1, wherein adjacent ones of said discrete material sections are of different materials joined together during curing.

9. The frame of claim 8, wherein said different materials include a difference in pigment.

10. The frame of claim 8, wherein said discrete material sections are placed together in the form of said frame portion and cured at once.

11. The frame of claim 1, wherein said discrete material sections are formed as said frame portion at one time.

12. The frame of claim 1, wherein said frame portion is the entirety of said main portion and said earpiece portions.

13. The frame of claim 1, wherein said frame portion includes at least one of said earpiece portions but not said main portion.

14. The frame of claim 1, wherein said frame portion includes said main portion but not said earpiece portions.
